(19) United States
(12) Patent Application Publication
(10) Pub. No.: US 2012/0145578 A1
(43) Pub. Date: Jun. 14, 2012

(54) SECURE PREPAID CARD PACKAGE ASSEMBLY

(75) Inventors: Sharon Pazlar, Ham Lake, MN (US); Michael Nundahl, New Brighton, MN (US)

(73) Assignee: FISERV, INC., Brookfield, WI (US)

(21) Appl. No.: 12/966,760

(22) Filed: Dec. 13, 2010

(51) Int. Cl. B65D 6/00; G06K 19/00; B65D 90/00; G06K 19/06

(52) U.S. Cl. 206/459.5; 235/494; 235/493; 235/487; 220/6

(57) ABSTRACT

A package assembly in accordance with an example embodiment can include a first panel having a first exterior side and a first interior side, and a second panel having a second exterior side and a second interior side. The first interior side may be arranged to face the second interior side, and the first panel can be sealed to at least a portion of the second panel to define a pocket. The pocket can be configured to be of an appropriate size to accept and conceal a prepaid card. A tear strip can be provided for accessing the prepaid card concealed in the pocket. The tear strip may be accessible from either the first exterior side or the second exterior side, and the tear strip may be completely formed within an interior portion of the one of the first panel or the second panel.

### FIELD OF THE INVENTION

Aspects of the invention relate generally to card packaging, and more specifically, to a secure card package assembly for a prepaid card.

### BACKGROUND OF THE INVENTION

Prepaid cards are available for activation and purchase at a variety of retail stores. In many cases, there is a need to ensure the security of a prepaid card prior to its activation at a point of sale in order to prevent fraud. In addition to ensuring the security of the prepaid card, there may be one or more other considerations relating to size, ease of activation, package attractiveness, information provisioning, ergonomics, and ease/cost of manufacture.

Accordingly, there is an opportunity in the industry for a secure card package assembly as described herein.

### BRIEF DESCRIPTION OF THE DRAWINGS

Reference will now be made to the accompanying drawings, which are not necessarily drawn to scale, and wherein:

FIGS. 1A and 1B illustrate respective interior and exterior views of an example two-panel card package assembly, according to an example embodiment of the invention.

FIGS. 2A and 2B illustrate respective interior and exterior views of an alternative to the two-panel card package assembly of FIGS. 1A and 1B, according to an example embodiment of the invention.

FIG. 3A illustrates an example application of adhesives to an interior side of an example two-panel cardholder prior to folding, according to an example embodiment of the invention.

FIG. 3B illustrates an example folding method for a two-panel cardholder, according to an example embodiment of the invention.

FIGS. 4A and 4B illustrate respective interior and exterior views of an example three-panel card package assembly, according to an example embodiment of the invention.

FIGS. 5A and 5B illustrate respective interior and exterior views of an alternative to the three-panel card package assembly illustrated in FIGS. 4A and 4B, according to an example embodiment of the invention.

FIG. 6A illustrates the application of adhesives to an interior side of an example three-panel cardholder prior to folding, according to an example embodiment of the invention.

FIG. 6B illustrates an example folding method for a three-panel cardholder, according to an example embodiment of the invention.

FIGS. 7A and 7B illustrate the use of hanging extension portions for respective two-panel card package assemblies, according to example embodiments of the invention.

FIGS. 8A-8C illustrate the use of hanging extension portions for respective three-panel card package assemblies, according to example embodiments of the invention.

FIG. 9 illustrates an example foldable sheet for inclusion in an example card package assembly, according to an example embodiment of the invention.

### DETAILED DESCRIPTION

The invention will now be described more fully hereinafter with reference to the accompanying drawings, in which example embodiments of the invention are shown. This invention may, however, be embodied in many different forms and should not be construed as limited to the example embodiments set forth herein; rather, these example embodiments are provided so that this disclosure will be thorough and complete, and will fully convey the scope of the invention to those of ordinary skill in the art. Like numbers refer to like elements throughout.

Embodiments of the invention may be directed to a card package assembly for a prepaid card. An example card package assembly may be comprised of a cardholder that completely conceals a prepaid card enclosed therein. The card package assembly may be displayed or otherwise made available to customers at a retail location, such as being hung or displayed on a carrier hook, shelf, kiosk, etc. Because the card package assembly completely conceals the prepaid card, the risk of fraud is minimized since the prepaid card package assembly must be torn or otherwise altered in order to access the prepaid card. Accordingly, a prepaid card may not be activated at a point of sale (POS) if the package assembly is torn or otherwise altered, thereby ensuring that security of the prepaid card prior to activation.

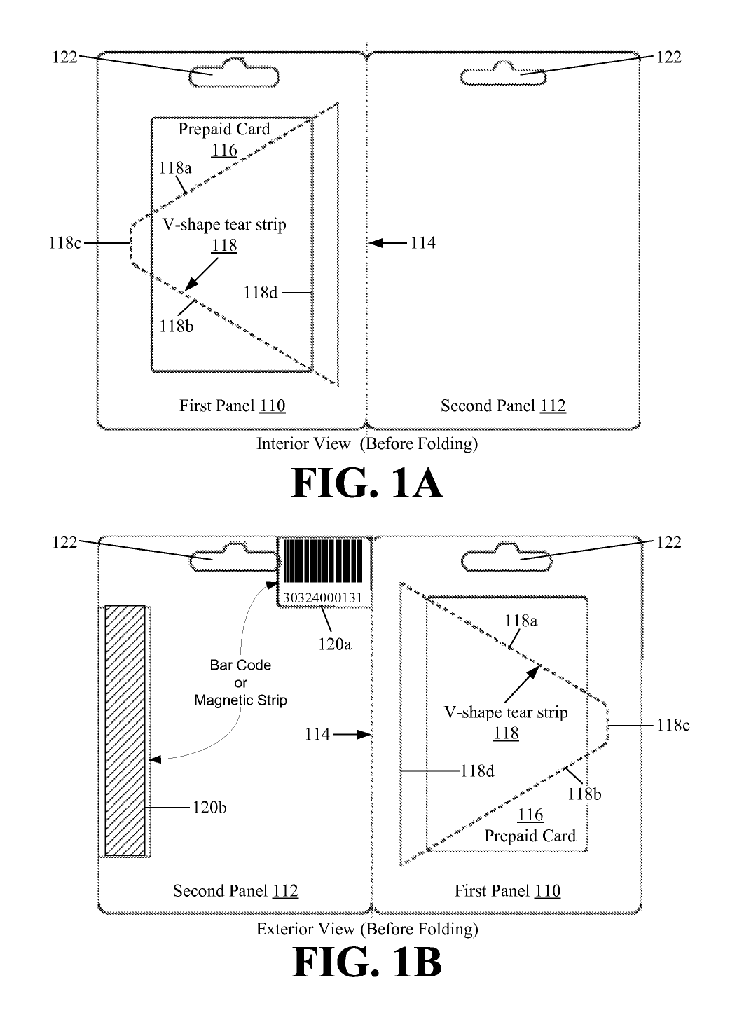

FIGS. 1A and 1B illustrate respective interior and exterior views of an example two-panel card package assembly, according to an example embodiment of the invention. More specifically, FIG. 1A illustrates an interior view of a two-panel card package assembly prior to folding. Likewise, FIG. 1B illustrates an exterior view of the two-panel card package assembly prior to folding. As shown in FIGS. 1A and 1B, an example card package assembly may include a cardholder that is comprised of a first panel 110 and a second panel 112, along with a prepaid card 116 that will be packaged and enclosed by the cardholder. The panels of the cardholder, including the first panel 110 and the second panel 112, may be formed of a variety of materials, including but not limited to, paper, cardboard, plastic, resin, polymers, laminate, or a combination thereof. Indeed, the first panel 110 and the second panel 112 may be formed of virtually any material that meets one or more requirements, including those relating to rigidity, size, weight, cost, and/or manufacturability.

As illustrated in FIGS. 1A and 1B, the cardholder may include a common edge 114 between the first panel 110 and the second panel 112. Accordingly, the first panel 110 and the second panel 112 may share a common edge 114 or may otherwise be connected by the common edge 114 (illustrated in dashed lines to indicate foldability). In some embodiments, the first panel 110 and the second panel 112 may be formed of a same card stock with the common edge 114 separating the first panel 110 and the second panel 112. The cardholder can then be folded along the common edge 114 such that the interior side of the first panel 110 faces or is directly opposite the interior side of the second panel 112. Accordingly, when the first panel 110 and the second panel 112 are folded along the common edge 114, a pocket may be defined for holding a prepaid card 116. In order to fully conceal the prepaid card 116 in the pocket, one or more security or adhesive means described herein can be applied in order to secure or adhere at least one or more common perimeter portions of the first panel 110 to the second panel 112. In some embodiments, the prepaid card 116 may optionally be removably affixed, perhaps using tape or an adhesive, to the interior side of the first panel 110, or alternatively to the interior side of the second panel 112, in order to prevent undesired shifting of the prepaid card 116 in the pocket. In addition, further information in the form of a pamphlet or informational sheet (e.g., terms and conditions) may also be included in the pocket. If desirable, one or more pamphlets or informational sheets can be affixed, either removably or not, to an interior side of the first panel 110 or the second panel 112. Alternatively, the information in the pamphlet or informational sheet, or yet other information relating to the prepaid card 116, can likewise be directly printed or otherwise provided on (e.g., on a sticker affixed to) one or both of the first panel 110 or the second panel 112 without departing from example embodiment of the invention. According to another alternative embodiment, the first panel 110 and the second panel 112 can be completely separated without any common edge as well.

Once the prepaid card 116 has been fully concealed in the pocket defined by the first panel 110 and the second panel 112, the prepaid card 116 (and any optional pamphlet or informational sheet) included in the pocket may not be visible or accessible when viewing the cardholder from the exterior sides of either the first panel 110 or second panel 112. Instead, access to at least the prepaid card 116 may be provided by a tear strip, which may be a V-shape tear strip 118 (illustrated as dashed lines to show separability or tearability) formed on the first panel 110, or alternatively on the second panel 112. The V-shape tear strip 118 may be completely formed on an interior portion (e.g., within the edges) of either the first panel 110 or the second panel 112. In other words, no portion of the V-shape tear strip 118 may include any edge of the first panel 110 or the second panel 112. However, the V-shape tear strip 118 may be visible and accessible from an exterior side of the first panel 110 or second panel 112 once the cardholder has been folded. The forming of the V-shape tear strip 118 only on or within the interior portion of the first panel 110 or the second panel 112 may facilitate adhering or securing of the perimeters of first panel to the second panel to provide the secured pocket for holding the prepaid card 116.

The V-shape tear strip 118 may be formed by perforations or perforated holes provided on or within the first panel 110 or the second panel 112. The size and spacing of the perforations or perforated holes may be based upon the biasing force that will be provided by the contents of the pocket, including at least the prepaid card 116, in order to securely maintain the contents in the pocket until the package assembly is opened by a customer. Likewise, the size and the spacing of the perforations or perforated holes may allow a customer to easily open the cardholder following activation of the prepaid card 116 enclosed in the card package assembly. It will be appreciated that instead of perforations or perforated holes, the V-shape tear strip 118 may alternatively be formed using a pull-string or pull-strip that is formed on or within the first panel 110 or the second panel 112. The pull-string or pull-strip may be formed of a variety of materials, including animal sources (e.g., wool, silk, etc.), plant sources (e.g., cotton, flax, jute, etc.), mineral sources (glass fiber, etc.), and synthetic sources (e.g., plastics, polyester, acrylic, etc.). According to another alternative, the V-shape tear strip 118 can also be formed using a combination of perforations (or perforated holes) and a pull-string or pull-strip. For example, a pull-string or pull-strip may be provided in conjunction with the perforations or perforated holes to facilitate the opening of the card package assembly. Alternatively, a first portion of the V-shape tear strip 118 may be a pull-string/pull-strip and a second portion of the V-shape tear strip 118 may be perforations or perforated holes. In another example embodiment, at least a portion of the V-shape tear strip 118 could also be of the same material as the first panel 110 or second panel 110, but be formed substantially in accordance with double lines, parallel pull-strings/pull-strips, or parallel perforations such that there is a throwaway tear strip (e.g., e.g., one line on each side to of a V) when torn.

According to an example embodiment, the tear strip 118 can be formed in a variety of shapes that resemble a “V” (e.g., a wide V shape, a narrow V shape). For example, in FIGS. 1A and 1B, the V-shape tear strip 118 includes a first diagonal section 118a and a second diagonal section 118b positioned in a way to form a tapered narrow end and a wide end. In some embodiments, the V-shape tear strip 118 may include a third section 118c that connects the first diagonal section 118a and the second diagonal section 118b at the narrow end. The third section 118c may be used as a tab or finger opening for tearing open the cardholder using the V-shape tear strip 118. In some embodiments, the third section 118c may have a slight gap or opening to the panel below in order to allow an easy point to start tearing the tear strip 118. As shown in FIGS. 1A and 1B, the wide end of the first diagonal section 118a and the second diagonal section 118b may form a hinged end 118d that allows the V-shape tear strip 118 to remain attached to the first panel 110 once opened or torn. However, in some example embodiments, the hinged end 118d can also be perforated or provided with a pull-string/pull-strip such that the V-shape tear strip 118 can be completely separated from the first panel 110 if desired.

According to an example embodiment, an example card package assembly may also include an optional cutout hole 122 in the respective first panel 110 and the second panel 112. The cutout hole 122 may enable the card package assembly to be displayed or hung on a display hook, perhaps on a J-hook of a display stand at a retail location, according to an example embodiment of the invention. The cutout hole 122 may be in the shape of a circle, an oval, a sombrero, or virtually any other shape corresponding to the type of hook being used to hang the card package assembly. Alternatively, the card package assembly can be displayed or stacked on shelving or the like without the use of the cutout hole 122, according to an example embodiment of the invention.

The prepaid card 116 in the card package assembly may remain unactivated until a customer brings the card package assembly to a checkout register or other checkout station to activate the prepaid card 116. To support the activation process, the exterior sides of the first panel 110 and/or second panel 112 can include one or more visible identifiers, either printed on the first panel 110 and/or second panel 112 or provided on a sticker affixed to the first panel 110 and/or the second panel 112. For example, FIG. 1B illustrates visible identifiers on an exterior side of the second panel 112 to support the activation and loading of monetary value for the prepaid card 116. The visible identifiers can be in the form of a first bar code or magnetic strip 120a and a second bar code or magnetic strip 120b. The first bar code or magnetic strip 120a can identify to the point of sale (POS) that a prepaid card 116 is being purchased. The second bar code or magnetic strip 120b can include identification information needed for activating the prepaid card 116 at the point of sale (POS). For example, the second bar code or magnetic strip 120b can include an activation ID that may be utilized at a point of sale (POS) to activate and load monetary value into a particular account associated with the prepaid card 116. At a checkout register or checkout station, the cashier may first scan the first bar code or magnetic strip 120a to identify that a prepaid card 116 is being purchased. The cashier may then scan the second bar code or magnetic strip 120b to load monetary value onto the account associated with the prepaid card 116. It will be appreciated that the bar codes or magnetic strips 120a, 120b can be strategically positioned on certain portions or edges of the exterior sides of the first panel 110 or the second panel 112 to facilitate scanning or swiping using bar-code readers or magnetic strip readers. For example, if the bar code or magnetic strip 120b is to be read by a magnetic strip reader, then the magnetic strip 120b may be located along an edge of the card package assembly so that the card package assembly can be swiped by the magnetic strip reader to read the information from the magnetic strip 120b. It will be appreciated that in some embodiments, a single bar code or magnetic strip can be utilized instead of respective bar codes or magnetic strips 120a, 120b. In some embodiments, to achieve a desired security of the prepaid card 116, no visible number associated with either the bar code or magnetic strip may correspond directly to a number (e.g., an account number, a card number) on or of the prepaid card 116.

It will be appreciated that a variety of information, both graphical and textual, can be printed directly on (or printed on a sticker affixed to) the interior and exterior sides of one or both of the first panel 110 and the second panel 112, according to an example embodiment of the invention. Indeed, a manufacturer, sponsor, or distributor of the prepaid card package assembly can include any advertisements or informational content as needed to support the activation, purchase, use, and/or marketing of the prepaid card package assembly.

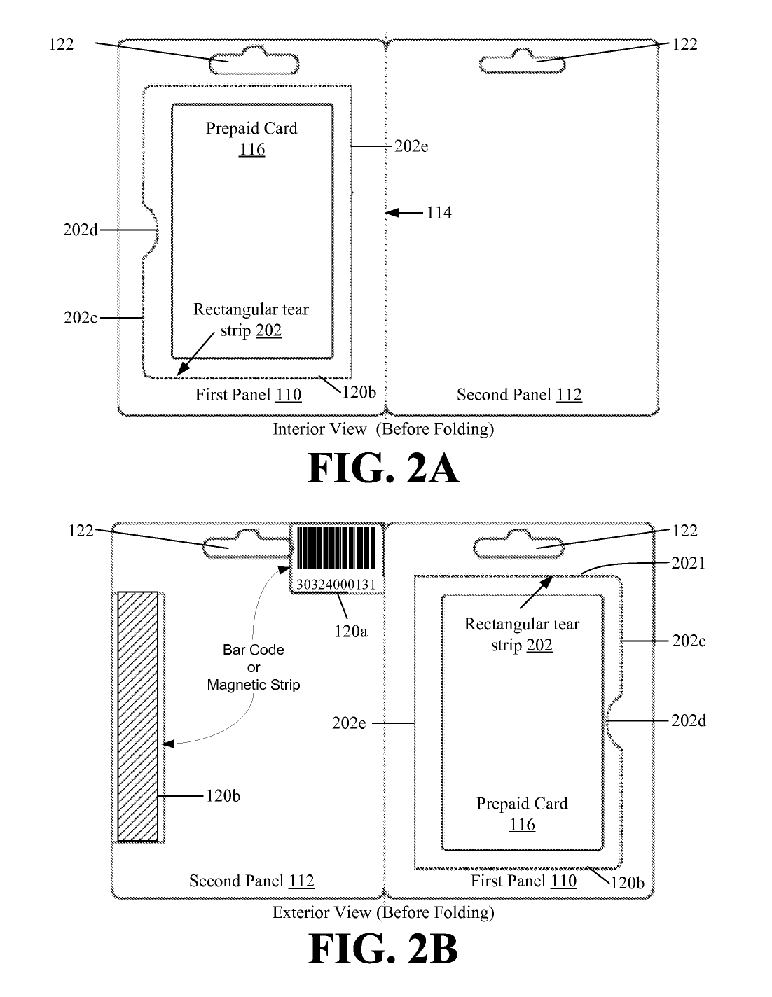

FIGS. 2A and 2B illustrate respective interior and exterior views of an alternative to the two-panel card package assembly of FIGS. 1A and 1B, according to an example embodiment of the invention. In particular, FIGS. 2A and 2B illustrate a card package assembly having a first panel 110, a second panel 112, and a prepaid card 116, as similarly described with respect to FIGS. 1A and 1B. However, in FIGS. 2A and 2B, the tear strip 202 (illustrated as dashed lines to show separability or tearability) may be formed in a variety of shapes that resemble a rectangle (e.g., a wide rectangle, a narrow rectangle, a square as a special case of a rectangle, etc.). Similar to the V-shape tear strip 118, the rectangular-shape tear strip 202 may be formed using perforations (or perforated holes) or a tear strip, as previously described herein.

In FIGS. 2A and 2B, the rectangular-shape tear strip 202 includes a first section 202a and a second section 202b arranged substantially in parallel. A third section 202c may be substantially perpendicular to the first and second sections 202a, 202b, and may further connect the first and second sections 202a, 202b at one end. In some embodiments, the third section 202c may further include an indented or tabbed portion 202d to facilitate the opening of the cardholder using the rectangular-shape tear strip 202. In some embodiments, the indented or tabbed portion 202d may have a slight gap or opening to the panel below in order to allow an easy point to start tearing the tear strip 202. As shown in FIGS. 2A and 2B, there may also be a hinged end 202e that is substantially parallel to the third section 202c, and may connect an opposite end of the first and second sections 202a, 202b. The hinged end 202e may allow the rectangular-shape tear strip 202 to remain attached to the first panel 110 once opened. However, in some example embodiments, the hinged end 202d can also be perforated or provided with a pull-strip such that the rectangular-shape tear strip 202 can be completely separated from the first panel 110 if desired.

In some embodiments, the exterior and/or interior side of the rectangular-shape tear strip 202 can be printed with certain information or instructions relating to the prepaid card 116, as described herein. The rectangular-shape tear strip 202 can also provide for easy access to the prepaid card 116 once opened or torn because the opening provided by the rectangular-shape tear strip may be larger than the size of the prepaid card 116, according to an example embodiment of the invention.

It will be appreciated that the shapes of the tear strips may be illustrated herein as V-shapes or rectangular shapes for illustrative purposes only. Indeed, it will be appreciated that the tear strips can be of virtually any shape that can be completely formed within an interior portion of a panel of the cardholder. In this regard, the tear strip can be formed in the shape of a circle, an ellipse, a trapezoid, a triangle, a star, a hexagon, an octagon, any other polygon shape, or any other regular or irregular shape without departing from example embodiments of the invention. It will be appreciated that the particular shape to be used for the tear strip may depend upon factors such as ease of opening, preferences for full or partial exposure of the enclosed card upon opening, printability and marketing preferences, and/or ease of identification of tampering. Similarly, while the prepaid card has been illustrated as a rectangle, it can likewise be virtually any shape that is compatible with a card reader for reading the magnetic strip or other indicia from the prepaid card.

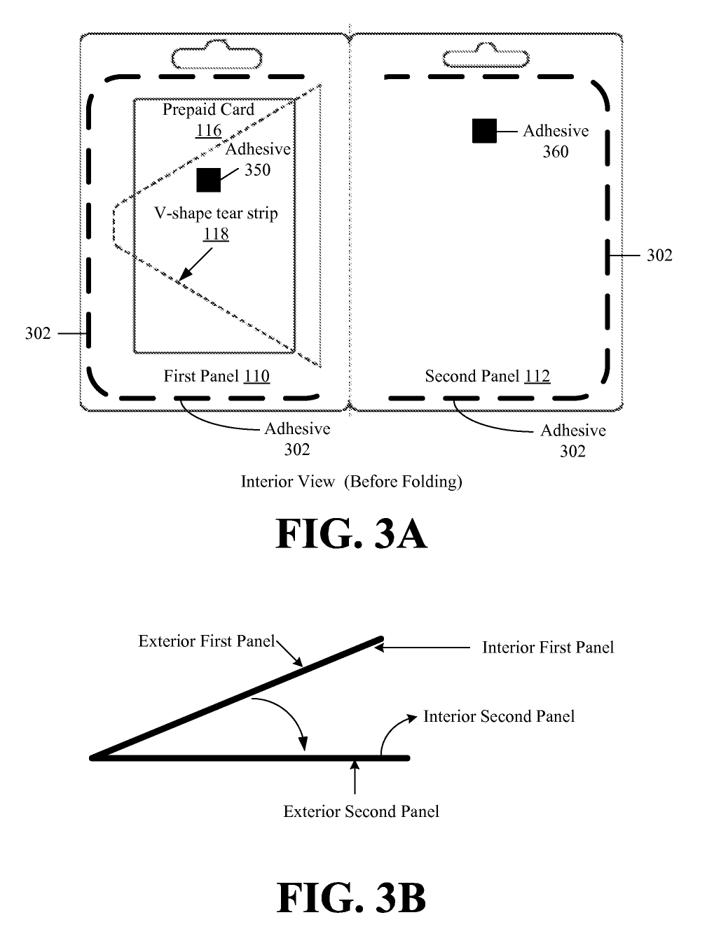

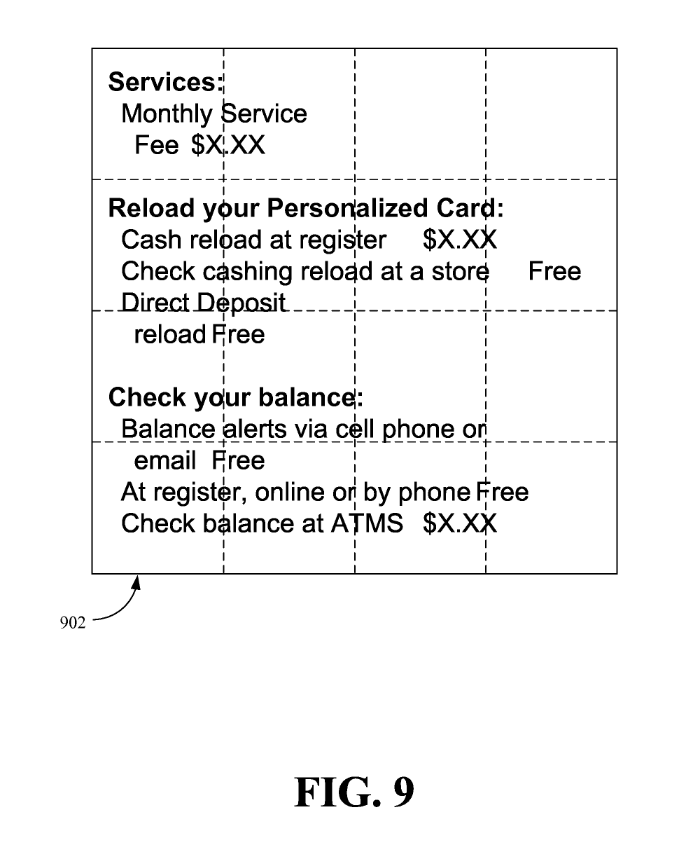

FIG. 3A illustrates an example application of adhesives to an interior side of an example two-panel cardholder prior to folding, according to an example embodiment of the invention. In particular, as shown in FIG. 3A, one or more beads of adhesive 302 may be applied to one or more perimeters of the interior side of the first panel 110 and/or the second panel 112. The adhesive 302 may be applied outside of the perimeter of the prepaid card and the tear strip, according to an example embodiment of the invention. Although the adhesive 302 has been illustrated in FIG. 3A in dashed lines, it will be appreciated that the adhesive can be in one or more continuous lines or beads according to an example embodiment of the invention. The adhesive 302 may also be selected to enhance the security of the cardholder when folded; as such, the adhesive 302 may be of the type that would allow the cardholder to be resealed without evidence of a prior tampering or opening. In addition, one or more beads of adhesive 350 may likewise be applied to removably adhere the prepaid card 116 to the interior side of the first panel 110 or the second panel 112. Likewise, one or more beads of adhesive 360 may be applied to the interior side of the second panel 112 or the first panel 110 to adhere one or more informational cards or foldable informational sheets, such as the foldable sheet discussed with respect to FIG. 9. The adhesives 302, 350, 360 may be applied using a glue gun, perhaps positioned in accordance with a Ga-Vehron machine or another similar mechanical machine that facilitates the folding of the cardholder. Once the adhesive 302 (and optionally, adhesives 350, 360) has been applied to the interior side of the cardholder, the cardholder may be folded along the common edge 114, and the adhesive 302 may adhere the interior sides of the first panel 110 and second panel 112 together such that the perimeter of the cardholder remains substantially sealed, thereby fully concealing the prepaid card 116 in the card package assembly until the tear strip is opened or torn. An example method of folding the first panel 110 and the second panel 112 is illustrated in FIG. 3B.

The adhesives utilized with the cardholder may be animal-based adhesives (e.g., casein glue, etc.), resin adhesives (e.g., Ethylene Viny Acetate (EVA), Poly Vinyl Acetate (PVA)), starch-based adhesives, latex-based adhesives, film adhesives, tape adhesives, waxes, silicone, and other polymer-based adhesives. It will be appreciated that instead of an adhesive, thermal sealing can also be utilized to seal the perimeter of the cardholder where the first and second panels 110, 112 are formed of plastic, polymers, resin, laminate, and other materials that may seal, melt, or otherwise bond together when heated, according to an alternative embodiment of the invention.

While FIG. 3A illustrates the application of the adhesives 302, 350, 360 to the cardholder of FIGS. 1A and 1B, it is likewise applicable to the cardholder of FIGS. 2A and 2B without departing from example embodiments of the invention.

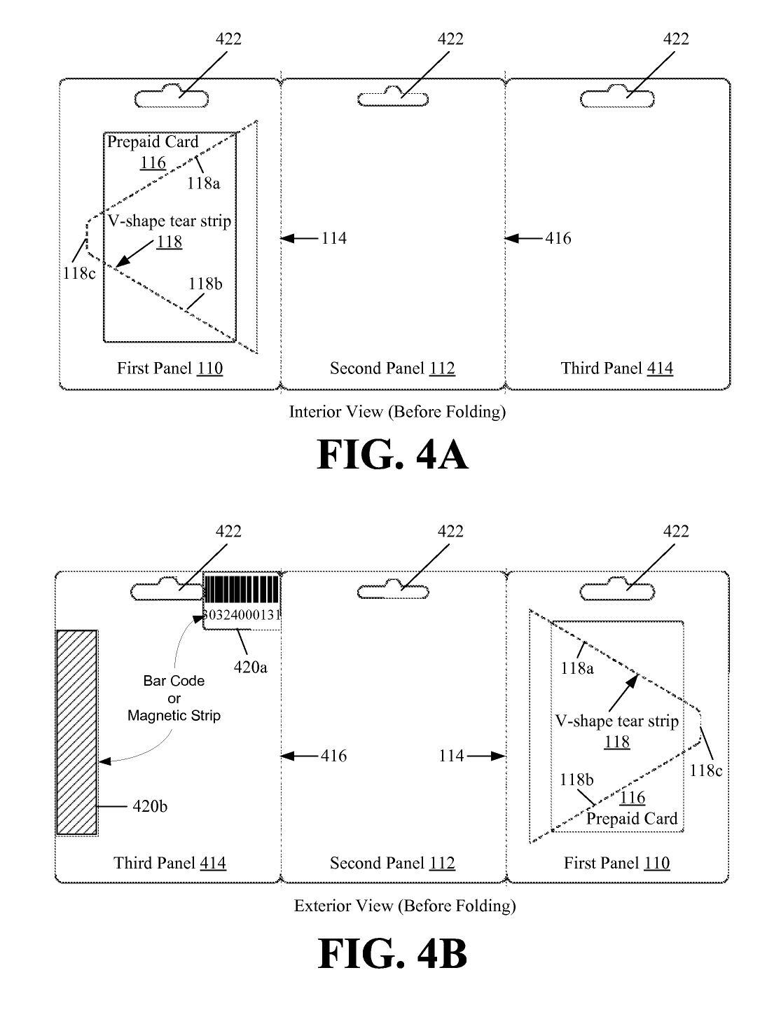

FIGS. 4A and 4B illustrate respective interior and exterior views of an example three-panel card package assembly, according to an example embodiment of the invention. More specifically, FIG. 4A illustrates an interior view of a three-panel card package assembly prior to folding. Likewise, FIG. 4B illustrates an exterior view of the three-panel card package assembly prior to folding. As shown in FIGS. 4A and 4B, an example card package assembly may include a cardholder that is comprised of a first panel 110 and a second panel 112, and a common edge between a first panel 110 and the second panel 112, as similarly described with respect to FIGS. 1A and 1B above. In particular, the cardholder can be folded along the common edge 114 such that the interior side of the first panel 110 faces or is directly opposite the interior side of the second panel 112. Accordingly, when the first panel 110 and the second panel 112 are folded along the common edge 114, a pocket may be defined for holding a prepaid card 116. The pocket for holding the prepaid card 116, and the access to the prepaid card 116 via the V-shape tear strip 118 on the first panel 110, has been discussed with respect to FIGS. 1A and 1B.

However, FIGS. 4A and 4B further provide for a third panel 414 that is connected to the second panel by a common edge 416 (illustrated in dashed lines to indicate foldability). In addition, there may also be one or more visible identifiers on an exterior side of the first panel 110, the second panel 112, and/or the third panel 414 to support the activation and loading of monetary value for the prepaid card 116. In FIGS. 4A and 4B, there may be a first bar code or magnetic strip 420a and a second bar code or magnetic strip 420b on the exterior side of the third panel 414; however, in other embodiments, the bar codes or magnetic strips 420a, 420b can also be provided on the exterior side of the first panel 110 and/or the second panel 112 as well. Bar codes or magnetic strips 420a, 420b may be substantially similar to bar codes or magnetic strips 120a, 120b previously discussed with respect to FIGS. 1A and 1B. Likewise, cutout holes 422 may be provided in the first, second, and third panels 422 so that the card package assembly can be displayed or hung on a display hook. The cutout holes 422 are similar to the cutout holes 122 discussed with respect to FIGS. 1A and 1B. Further, all or some of the first panel 110, the second panel 112, and/or the third panel 414 can be separate panels that are not connected by any common edges. Where the panels are embodied as separate panels, they may be glued, taped, adhered and/or sealed to one or more other panels, according to an example embodiment of the invention.

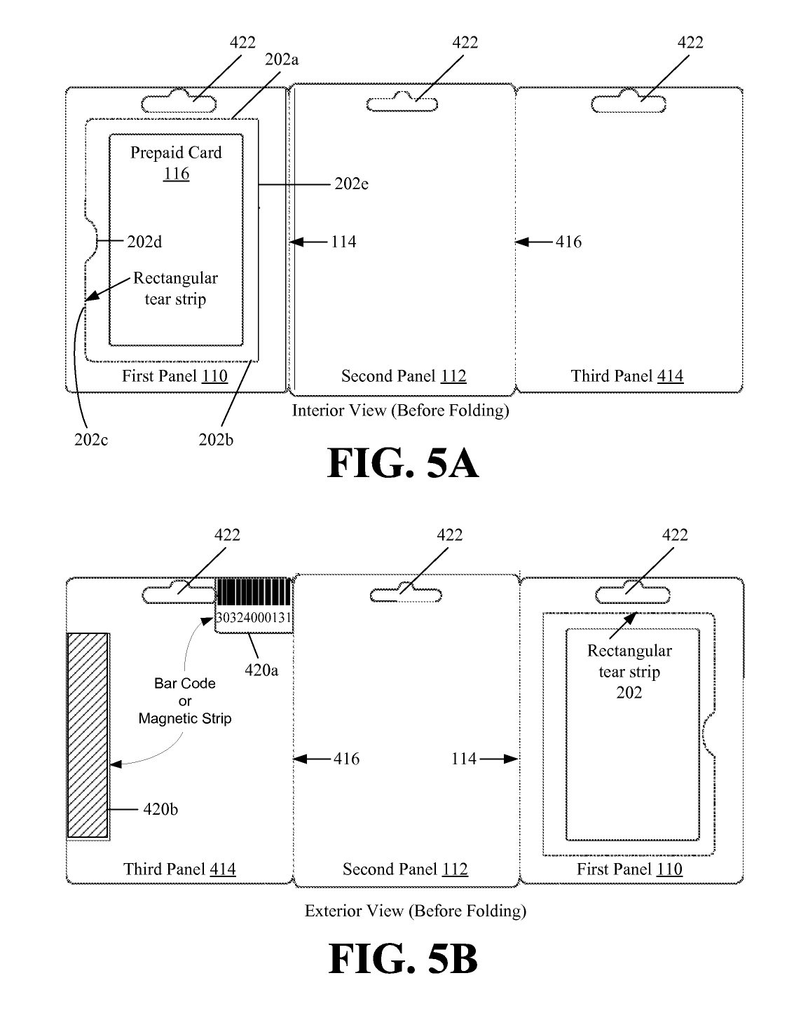

FIGS. 5A and 5B illustrate respective interior and exterior views of an alternative to the three-panel card package assembly of FIGS. 4A and 4B, according to an example embodiment of the invention. The three-panel card package assembly of FIGS. 5A and 5B is similar to that described with respect to FIGS. 4A and 4B above. However, in FIGS. 5A and 5B, a rectangular-shape tear strip 202 may be utilized instead of the V-shape tear strip of FIGS. 4A and 4B. The rectangular-shape tear strip 202 was previously discussed with respect to FIGS. 2A and 2B, and need not be discussed in further detail. However, as similarly discussed with respect to FIGS. 2A and 2B, other alternative shapes may be utilized instead of a rectangle-shape tear strip 202.

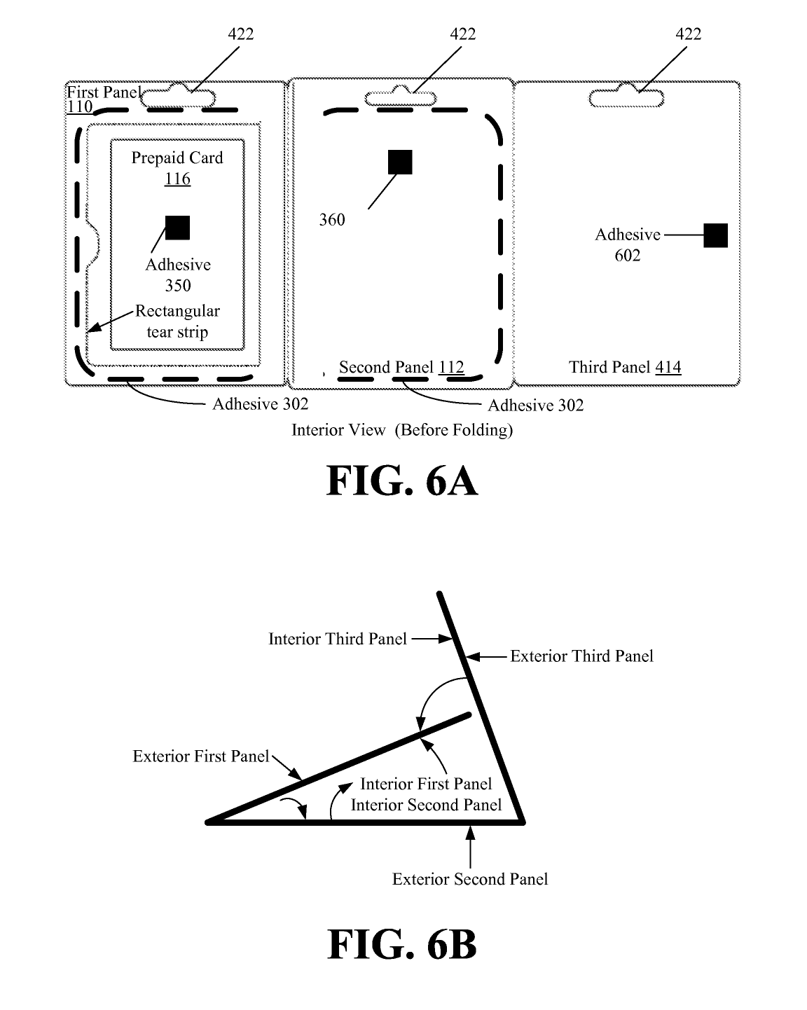

FIG. 6A illustrates the application of adhesives to an interior side of an example three-panel cardholder prior to folding, according to an example embodiment of the invention. In particular, as shown in FIG. 6A, one or more beads of adhesive 302 may be applied to one or more perimeters of the interior side of the first panel 110 and/or the second panel 112, as similarly discussed with respect to FIG. 3A. Likewise, one or more beads of adhesive 350 may be applied to removably adhere the prepaid card 116 to the interior side of the first panel 110 or the interior side of second panel 112. Similarly, one or more beads of adhesive 602 may be applied to the second panel 112 or the third panel 414 to adhere one or more informational cards or foldable informational sheets, such as the foldable sheet of FIG. 9.

The cardholder may be folded along the common edge 114, and the adhesive 302 may adhere the interior sides of the first panel 110 and second panel 112 together such that the perimeter of the cardholder remains substantially sealed, thereby fully concealing the prepaid card 116 in the card package assembly until the tear strip is opened or torn. In addition, the third panel 414 may optionally include an adhesive 602 on its interior side to adhere the interior side of the third panel 414 to the exterior side of the first panel 110 when the cardholder is folded according to FIG. 6B. Alternatively, the third panel 414 could have included the optional adhesive 602 on the exterior side of the third panel 414, and the third panel 414 could have been folded in a clockwise manner such that the exterior side of the third panel 414 adheres to the exterior side of the second panel 112. It will be appreciated that instead of an adhesive, a security seal or tape could also be applied to seal the common perimeter between the exterior third panel and the folded first and second panels 110, 112. In some embodiments, the third panel 414 may not necessarily be sealed at one end to allow the third panel 414 to swing open. For example, a customer may be permitted to browse the information printed on or affixed to the interior and exterior sides of the third panel 414 prior to purchasing the card package assembly.

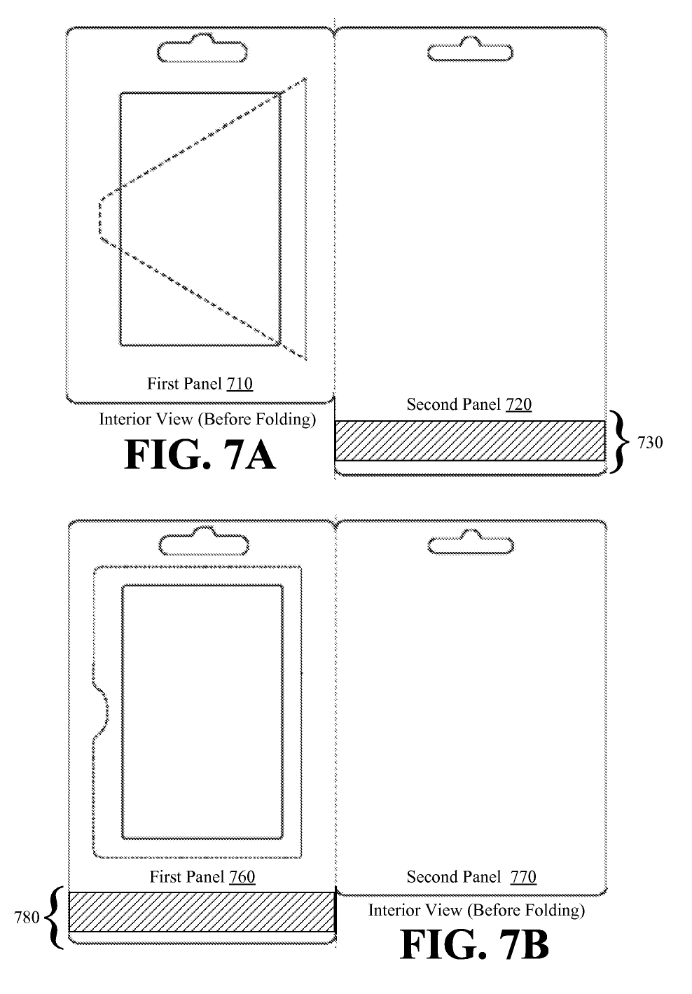

FIGS. 7A and 7B illustrate the use of hanging extension portions for respective two-panel card package assemblies, according to example embodiments of the invention. In particular, as shown in FIG. 7A, the first panel 710 may be similar to the first panel 110 of FIGS. 1A-1B or FIGS. 2A-B. However, the second panel 720 may be larger than the first panel 710 such that an extension portion 730 may be provided for the second panel 720. The extension portion 730 of the second panel 720 may be visible even after the first panel 710 has been folded to face the second panel 720, as similarly discussed with respect to FIG. 3B. One or both sides of the extension portion 730 may be used to include one or more visible identifiers to support the activation or loading of monetary value for a prepaid card 116. For example, one or more visible identifiers may be printed on either side of the extension portion 730, or provided on a sticker affixed to either side of the extension portion 730. These one or more visible identifiers can be similar to bar codes or magnetic strips 120a, 120b, 420a, 420b, as discussed herein. The extension portion 730 can also be utilized to print any additional information relevant to the prepaid card as well without departing from example embodiments of the invention. FIG. 7B is an alternative embodiment of a hanging extension for a two-panel card package assembly. In particular, in FIG. 7B, the first panel 760 may be larger than the second panel 770 such that an extension portion 780 may be provided for the first panel 760. The extension portion 780 may include one or more visible identifiers or any other information, as discussed herein. Accordingly, it will be appreciated that an extension portion may be located on either panel of a two-panel card package assembly, according to example embodiments of the invention. Likewise, while the hanging extension has been illustrated at the bottom on one of the panels, it can also be embodied on the top of a panel or on a side of a panel as well.

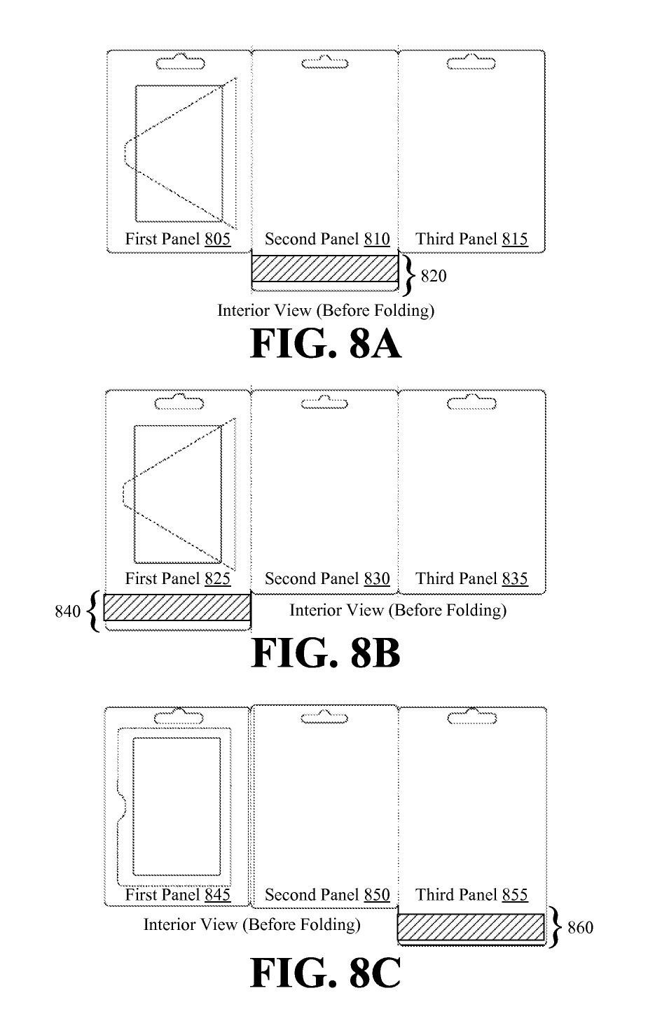

FIGS. 8A-8C illustrate the use of hanging extensions for respective three-panel card package assemblies, according to example embodiments of the invention. In FIG. 8A, there may be a first panel 805, a second panel 810, and a third panel 815. The first panel 805 and the third panel 815 may be similar to the respective panels 110, 414 of FIGS. 4A-4B or 5A-5B. However the second panel 810 may be larger than the first and third panels 805, 815 such that the extension portion 820 may be provided for the second panel 810. The extension portion 820 of the second panel 810 may be visible even after the first, second, and third panels 805, 810, 815 have been folded, as similarly discussed with respect to FIG. 6B. One or both sides of the hanging extension portion 820 may be used to include one or more visible identifiers or any other information relevant to the prepaid card, as similarly discussed herein.

FIGS. 8B and 8C illustrate alternative embodiments of respective hanging extensions for respective three-panel card package assemblies. In particular, in FIG. 8B, the first panel 825 may be larger than the second and third panels 830, 835 such that an extension portion 840 may be provided for the first panel 825. In FIG. 8C, the third panel 855 may be larger than the first and second panels 845, 850 such that an extension portion 860 may be provided for the third panel 855. These extension portions 840, 860 may include one or more visible identifiers or any other information, as discussed herein. Again, while the hanging extension has been illustrated at the bottom on one of the panels, it can also be embodied on the top of a panel or on a side of a panel (e.g., the first panel 825 or the third panel 835) as well without departing from example embodiments of the invention

It will be appreciated that additional panels can be utilized for the card package assembly beyond the two-panel and three-panel embodiments disclosed herein. For example, some embodiments may include four or more panels in accordance with alternative embodiments of the invention. These additional panels can contain additional printed information or form one or more second pockets for holding or enclosing one or more cards or information. For example, there may be a four-panel card package assembly in which the first and second panels can define a pocket for enclosing the prepaid card as described herein. However, the third and fourth panels can be form one or more second pockets for enclosing an additional card and/or information, including terms and conditions. The second pockets may not necessarily be completely sealed and could be accessible from at least one opening, depending upon the information to be included in the one or more second pockets. The first and second pockets may be folded along a common edge between the second and third panels to resemble a closed book.

Likewise, it will be appreciated that two or more respective panels described herein need not be connected to any other panel by a common edge. Instead, each panel may be formed from a respective card stock. In this regard, adhesives (e.g., tape, glue) or heat seals can be used to bind the perimeter of the panels in lieu of a common edge when constructing the card package assembly.

FIG. 9 illustrates an example foldable sheet 902 that may be included with a prepaid card package assembly according to an example embodiment of the invention. The sheet 902 in FIG. 9 has been illustrated with dashed lines to show its foldability. The foldable sheet 902 may include, for example, terms and conditions applicable to the prepaid card. In addition, the foldable sheet 902 can include promotional information or other information that may be relevant to a person with the prepaid card. In some example embodiments, the foldable sheet 902 may be folded to a size that is no larger than the prepaid card. The foldable sheet 902 can also be affixed to one of the panels of the card package assembly, as described herein.

Many modifications and other embodiments of the invention will come to mind to one skilled in the art to which this invention pertains and having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A package assembly, comprising:
a first panel having a first exterior side, and a first interior side;
a second panel having a second exterior side and a second interior side, wherein the first interior side is arranged to face the second interior side, the first panel sealed to at least a portion of the second panel to define a pocket, the pocket configured to be an appropriate size to accept and conceal a prepaid card; and
a tear strip accessible from one of the first exterior side or the second exterior side, the tear strip for accessing the prepaid card concealed in the pocket, the tear strip being completely formed within an interior portion of the one of the first panel or the second panel.

2. The package assembly of claim 1, wherein the tear strip is characterized as a V-shape tear strip or a rectangular tear strip.

3. The package assembly of claim 1, further comprising:
a third panel, wherein at least a portion of the third panel is adhered to the first or second panels.

4. The package assembly of claim 1, wherein the first panel is attached to the second panel according to a least one common edge, wherein the first panel and the second panel are folded along the at least one common edge, wherein at least a portion of common perimeters of the first panel and the second panel distinct from the at least one common edge are sealed together.

5. The package assembly of claim 4, wherein the at least one common edge is a first common edge and further comprising a third panel connected to the second panel along a second common edge, wherein the third panel has a third interior side and a third exterior side, and wherein the third interior side is folded against the first exterior side along the second common edge.

6. The package assembly of claim 5, wherein at least a portion of the third panel and the first panel are adhered together.

7. The package assembly of claim 1, further comprising:
a foldable sheet containing information associated with the prepaid card,
wherein the sheet containing information is folded and attached to one of the first interior side or the second interior side.

8. The package assembly of claim 1, wherein the prepaid card is removably affixed to one of the first interior side or the second interior side.

9. The package assembly of claim 1, wherein the tear strip comprises any of: (i) perforated holes, (ii) a pull string, or (iii) a combination of perforated holes and the pull string.

10. The package assembly of claim 1, wherein the first panel and the second panel are made of paper, cardboard, plastic, resin, polymers, laminate, or any combination of the foregoing.

11. The package assembly of claim 10, wherein the first panel is sealed to at least the portion of the second panel using one or both of (i) one or more adhesives or (ii) a heat seal.

12. The package assembly of claim 1, wherein the first panel and the second panel are sealed together based upon at least one of (i) the first interior side being sealed along a portion of its perimeter to the second interior side, or (ii) the first exterior side being sealed along a portion of its perimeter to the second exterior side.

13. The package assembly of claim 1, wherein the first panel contains a first cutout hole and the second panel contains a second cutout hole, and wherein the first cutout hole aligns with the second cutout hole upon folding the first panel against the second panel, to enable the package assembly to be hung on a display hook.

14. The package assembly of claim 1, further comprising at least one visible identifier on one or both of the first exterior side or the second exterior side to facilitate activation of the prepaid card at a point of sale.

15. The package assembly of claim 14, wherein one or more of the at least one visible identifier is at least one of (i) a bar code or (ii) a magnetic strip.

16. The package assembly of claim 14, wherein the first panel is larger than the second panel such that an extension portion is provided for the first panel, wherein the extension portion remains visible after the first panel is sealed to at least the portion of the second panel, wherein one or more of the at least one visible identifier is provided on one or both sides of the extension portion.

17. A package assembly, comprising:
a prepaid card not yet activated for use; and
a cardholder for the prepaid card, the cardholder comprising (i) a first panel and a second panel connected along a common edge and (ii) a visible identifier for use in activating the prepaid card,
wherein the first panel has a first interior side and a first exterior side, and the second panel has a second interior side and a second exterior side,
wherein the first interior side is folded against the second interior side along the common edge and at least a portion of the first panel and the second panel are sealed together such that the removably attached prepaid card is fully concealed between the first interior side and the second interior side,
wherein one of the first panel or the second panel has a tear strip which enables access to the prepaid card upon tearing, the tear strip being completely formed within an interior portion of the one of the first panel or the second panel.

18. The package assembly of claim 17, wherein the tear strip is characterized as a V-shape tear strip or a rectangular tear strip.

19. The package assembly of claim 17, wherein the common edge is a first common edge and further comprising a third panel connected to the second panel along a second common edge, wherein the third panel has a third interior side and a third exterior side, and wherein the third interior side is folded against the first exterior side along the second common edge.

20. The package assembly of claim 17, wherein the tear strip comprises any of: (i) perforated holes, (ii) a pull string, or (iii) a combination of perforated holes and the pull string.
